(19) United States
(12) Patent Application Publication
(10) Pub. No.: US 2017/0179777 A1
(43) Pub. Date: Jun. 22, 2017

(54) Gravity and Magnetic Motor

(71) Applicant: Abbas Panahi, San Jose, CA (US)

(72) Inventor: Abbas Panahi, San Jose, CA (US)

(21) Appl. No.: 14/970,665

(22) Filed: Dec. 16, 2015

(51) Int. Cl. H02K 1/27; H02K 7/08; H02K 53/00; H02K 1/17

(52) U.S. Cl. CPC H02K 1/27; H02K 1/17; H02K 7/08; H02K 53/00

(57) ABSTRACT

A motor device utilizing gravitational and magnetic forces in conjunction with a manual user input of energy. The motor device includes a support frame configured to support a plurality of L-shaped magnetic strips with an axle disposed in a horizontal orientation thereacross. A plurality of levers are mounted to the axle by a linear bearing having an arm slidably disposed therein. The arm has a magnet at each end that is repelled by the magnetic strips, causing the repelled end of the arm to slide through the linear bearing and elongating the opposing end of the arm. This creates an unbalanced fulcrum thereby rotating the arm. As the arm of the first lever rotates, the axle rotates causing all subsequent levers to rotate thereby driving the motor.

### BACKGROUND OF THE INVENTION

The present invention relates to motors. More specifically, the present invention relates to a motor utilizing gravitational and magnetic forces to rotate an axle.

Methods and machines exist that can be put into motion using various elements and forces. Many known motion machines have utilized heat energy, nuclear energy, or fuel to run. Some of these machines generate by-products that are pollutants and hazardous to the environment. Further, many of these machines generate heat that can become dangerous without a proper cooling mechanism. Therefore, there is a need for a clean energy motion machine that does not produce harmful by-products while energy moves through the system.

Clean energy motion machines exist in the prior art; however, many of these machines rely on uncontrollable natural forces to function. For example, a machine may require solar energy, wind, an ideal atmospheric pressure, or temperature changes to drive its motion. Therefore, there exists a need for a clean energy motion machine that utilizes controllable forces, such as magnets and user kinetic energy input.

### SUMMARY OF THE INVENTION

In view of the foregoing disadvantages inherent in the known types of magnetic and gravity powered motors now present in the prior art, the present invention is adapted to additionally receive a manual input of energy from a user thereby allowing the motor to run at a consistent pace. The present motor device comprises a support frame adapted to support a plurality of L-shaped magnetic strips having a plurality of internal permanent magnets. An axle is disposed in a horizontal orientation across the support frame and elevated above the magnetic strips. A plurality of levers are mounted to the axle by a linear bearing having an arm slidably disposed therein. The arm has a pair of ends, with a magnet at each end polarized to repel the L-shaped magnetic strips.

To start the motor device, a user can turn a hand crank connected to the axle, lift a first lever to a position parallel to the ground, or release a pin that holds a first lever in a position parallel to the ground. Gravitational forces cause the first lever to swing downward and pulling a first end of the first lever through the linear bearing thereby elongating the first end and shortening a second end. Kinetic energy from manually starting the motor causes the first end to continue rotating rotate upward along the magnetic strips. The magnetic strips repel the magnet attached to the first end causing the arm to repel through the linear bearing thereby elongating the second end of the arm. This creates an unbalanced fulcrum, which allows the first end of the arm to continue rotating upward while the second end of the arm rotates downward. The rotation of the first lever rotates the axle thereby causing subsequent levers to follow the same cycle.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the motor device.

FIG. 2 shows an interior view of a lever.

FIG. 3 shows an interior view of an alternative embodiment of a lever.

FIG. 4 shows a side view of the levers in motion in a first position.

FIG. 5 shows a side view of the levers in motion in a second position.

FIG. 6 shows a perspective view of an alternative embodiment of the motor device.

### DETAILED DESCRIPTION OF THE INVENTION

Reference is made herein to the attached drawings. Like reference numerals are used throughout the drawings to depict like or similar elements of the motor. For the purposes of presenting a brief and clear description of the present invention, the preferred embodiment will be discussed as used for generating an output of power from a manual input of energy acting with gravitational and magnetic forces. The figures are intended for representative purposes only and should not be considered to be limiting in any respect.

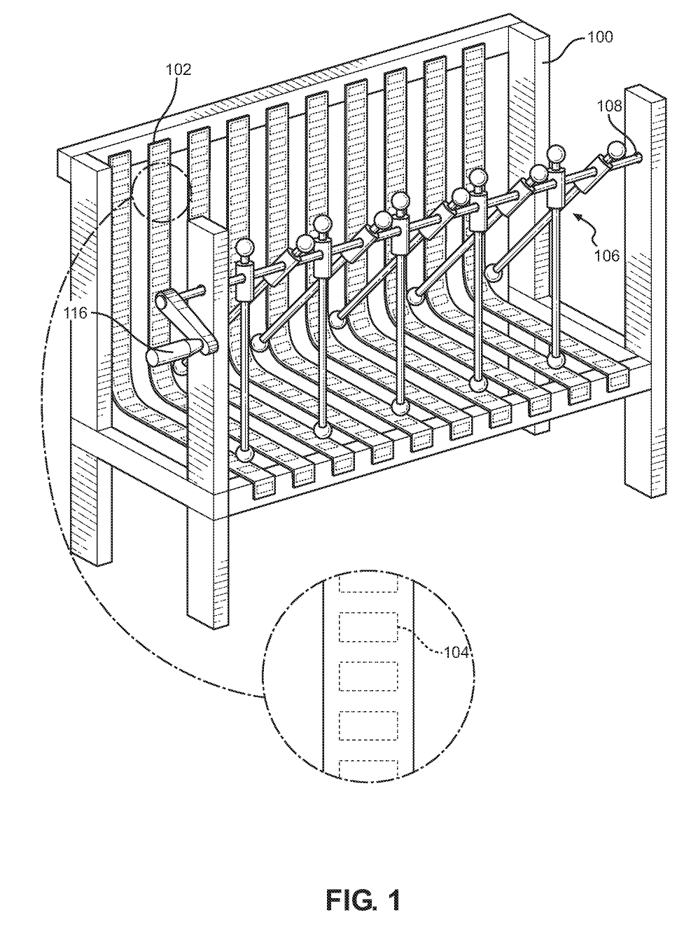

Referring now to FIG. 1, there is shown a perspective view of the motor device. In the depicted embodiment, the motor device comprises a support frame 100 adapted to support a plurality of L-shaped magnetic strips 102, wherein the magnetic strips 102 are parallel to one another and are separated at fixed intervals. In the depicted embodiment, the support frame 100 is rectangular having a plurality of legs. The support frame 100 enables the motor to be held in a stable position while it is running. The support frame 100 is composed of wood, plastic, or any similar suitable material that does not interfere with magnetic forces. The magnetic strips 102 are comprised of a plurality of internal permanent magnets 104. In the depicted embodiment, the internal permanent magnets 104 are also uniformly shaped and separated at fixed intervals.

A plurality of levers 106 are permanently mounted to an axle 108, wherein the axle 108 is disposed in a horizontal orientation and is elevated above the L-shaped magnetic strips 102. In the preferred embodiment, the levers 106 are uniformly shaped and equally spaced, aligning with the magnetic strips 102. In the depicted embodiment, the levers 106 are attached to the axle 108 at random degree differentials from each other. In the preferred embodiment, each lever is connected to the axle at a 90 degree differential from the previous lever. Therefore, the preferred embodiment comprises four levers.

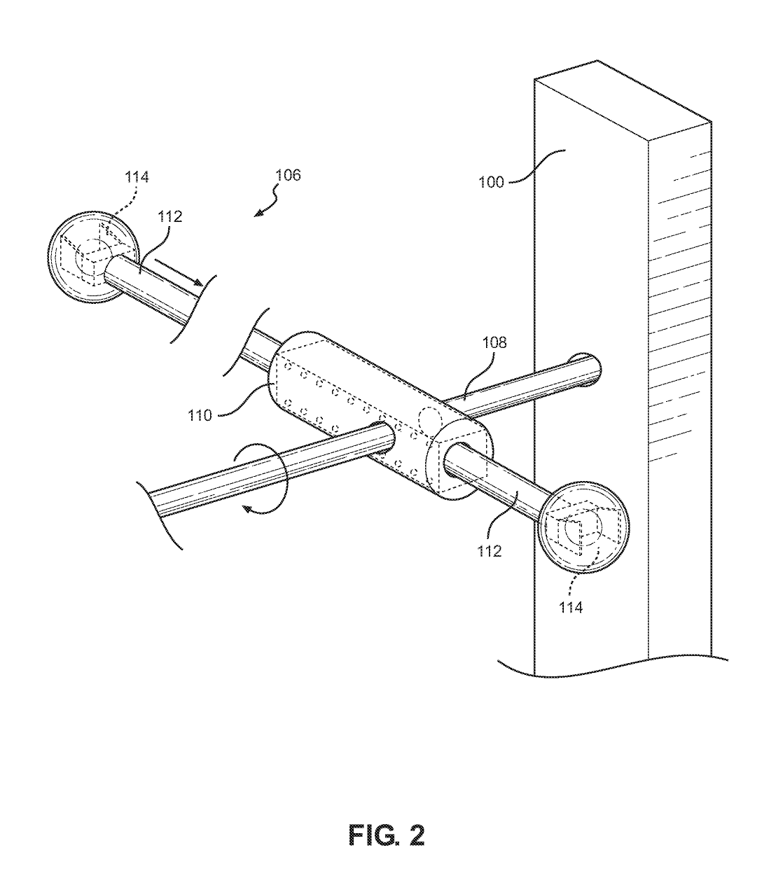

Referring now to FIG. 2, there is shown an interior view of a lever. The lever 106 comprises a linear bearing 110 affixed to the axle 108 in a perpendicular orientation and an arm 112 slidably disposed therein, such that the arm 112 can move in and out both ends of the linear bearing 110. The arm 112 has a pair of ends, each end comprising a magnet 114 thereon. In the preferred embodiment, the magnet 114 is a permanent magnet. Forces acting on the magnet 114 cause the arm 112 to slide in or out of an end of the linear bearing 110.

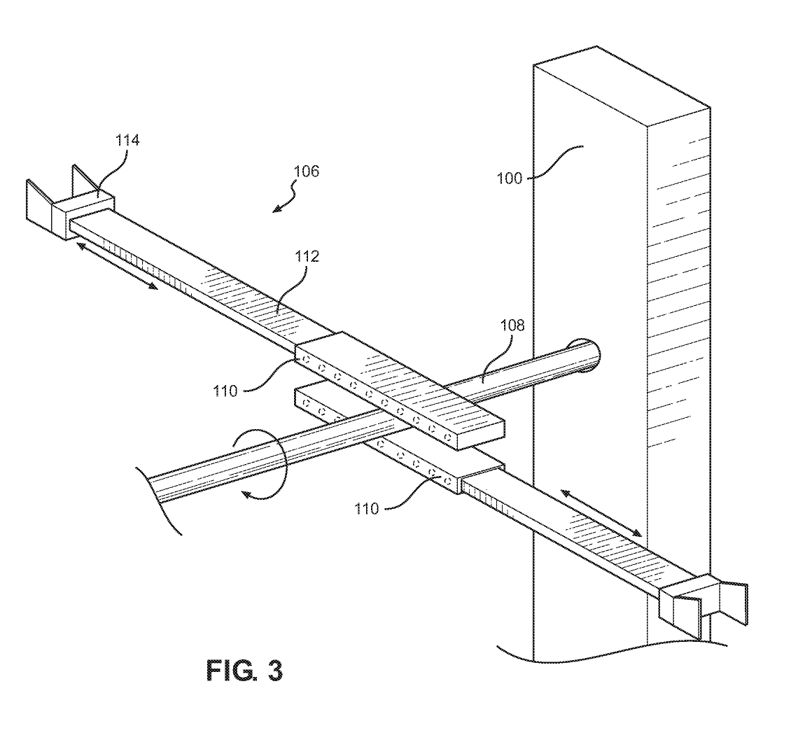

Referring now to FIG. 3, there is shown an alternative embodiment of a lever. In the depicted embodiment, the lever 106 comprises a pair of linear bearings 110 affixed to the axle 108 parallel to each other. The linear bearings 110 each comprise an arm 112 slidably disposed therein, such that the arm 112 can slide in and out a distal end of the linear bearing 110. In the depicted embodiment, each arm 112 further comprises a magnet 114 at a free end of the arm 112.

To start the motor, in the embodiment depicted in FIG. 1, the motor receives an input of energy from a hand crank 116. The hand crank 116 is connected to the axle 108 through the support frame 100. When a user turns the hand crank 116, the axle 108 begins to rotate thereby rotating the levers 106. In another embodiment, a first lever is secured parallel above the ground via a pin. When the pin is released, gravitational forces cause the first lever to swing downward thereby rotating the axle and subsequent levers. In an alternative embodiment, a first lever is perpendicular to the ground whereby a user lifts the first lever and then releases it, causing it to swing downward thereby rotating the axle and subsequent levers.

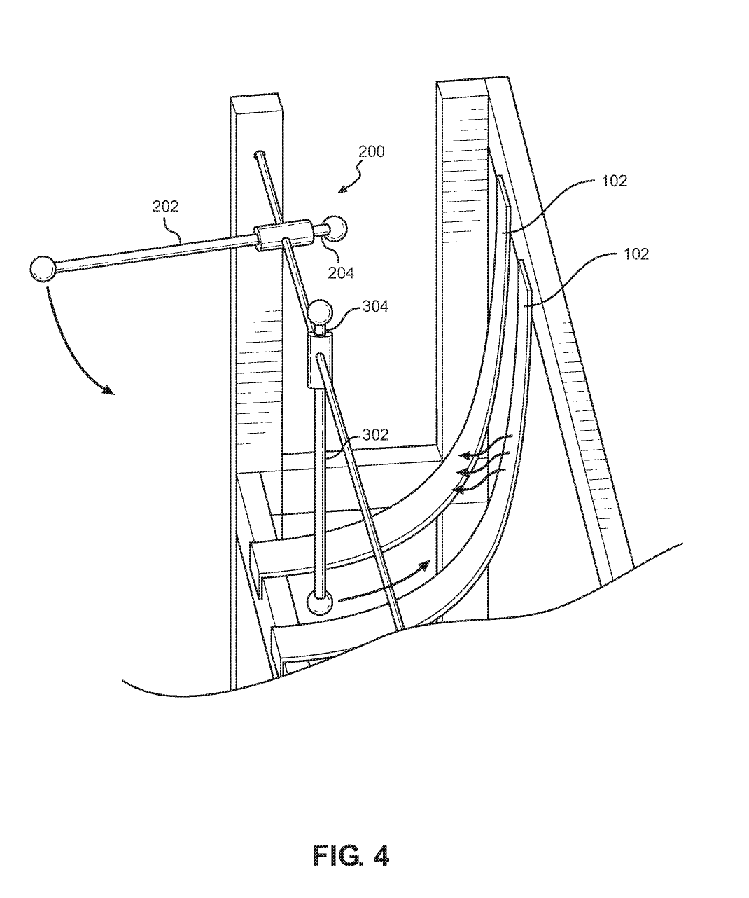

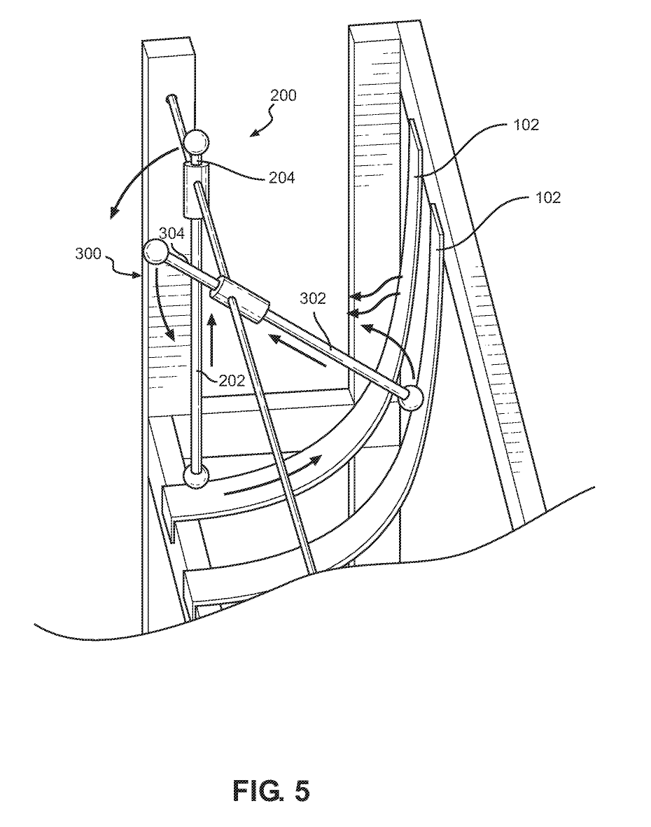

Referring now to FIGS. 4 and 5, there are shown side views of the levers in motion in a first position and a second position, respectively. In the depicted embodiment, a first lever 200 comprises an arm having a first end 202 and a second end 204, and a second lever 300 comprises an arm having a first end 302 and a second end 304. As shown in FIG. 4, from a first position parallel above the ground, gravity pulls the first end 202 of a first lever 200 downward. As the first end 202 is pulled downward, gravity pulls the arm through the linear bearing 110 thereby elongating the first end 202 of the first lever 200 and shortening the second end 204 of the first lever 200. After the first lever 200 has reached a position perpendicular to the ground, the kinetic energy from manually starting the motor causes the first lever 200 to continue rotating. Therefore, the first end 202 of the arm starts to rotate upward along the magnetic strips 102, as shown in FIG. 5.

Because the first lever 200 is permanently mounted to axle 108 via a linear bearing, rotation of the first lever 200 causes the axle 108 to rotate. When the axle 108 begins to rotate, it also rotates a second lever 300 that is permanently affixed thereto. While the first end 202 of the first lever 200 is pulled downward by gravity, the axle 108 rotates and forces the first end 302 of the second lever 300 to begin rotating upward along the magnetic strips 102.

As the first end 302 of the second lever 300 rotates upward along the magnetic strips 102, magnetic force from the internal permanent magnets 104 in each magnetic strip 102 repels the magnet 114 on the first end 302 of the second lever 300. Repulsion of the magnet 114 causes the arm to slide back through the linear bearing 110 thereby elongating the second end 304 of the second lever 300. As the first end 302 of the second lever 300 shortens, it creates an unbalanced fulcrum and the first end 302 continues to rotate upward as if it weighed less. As the shorter first end 302 of the second lever 300 rotates upward, gravity pulls the longer second end 304 downward, as shown in FIG. 5, and the cycle repeats.

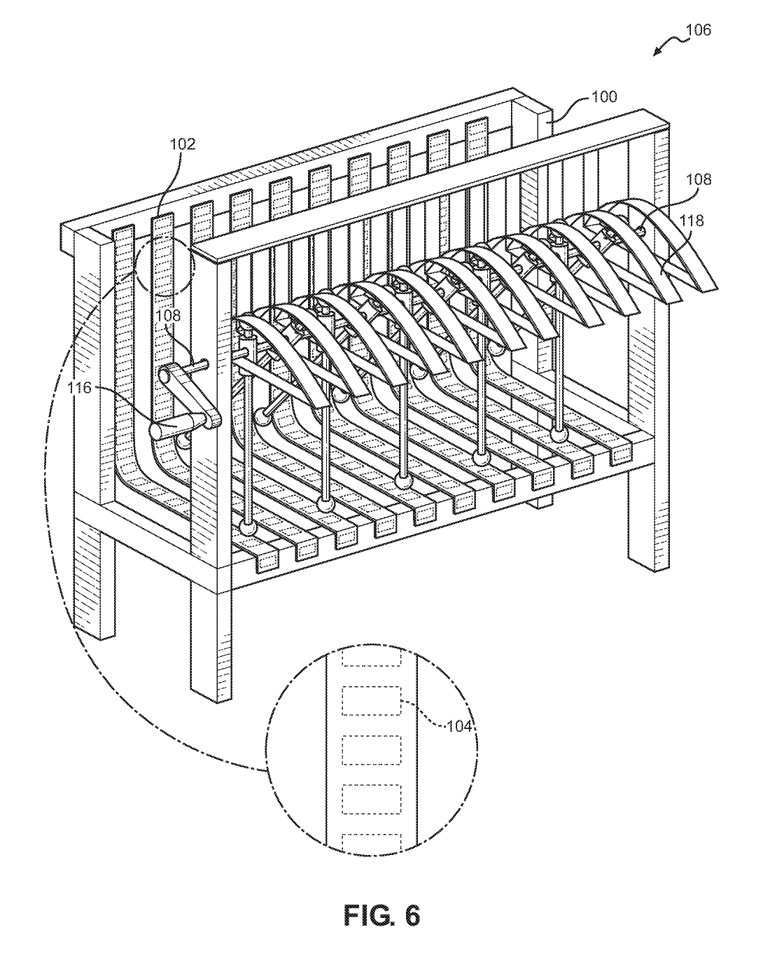

Referring now to FIG. 6, there is shown a perspective view of an alternative embodiment of the motor device. In the alternative embodiment, the support frame 100 further comprises a plurality of arcuate upper leading magnetic guides 118 mounted thereto. Each upper leading magnetic guide 118 comprises a plurality of internal magnets. Preferably, the upper leading magnetic guides 118 are positioned at fixed intervals such that they are on each side of every lever 106. The upper leading magnetic guides 118 provide an additional magnetic field that further propels an arm 112 of the lever 106 away from the L-shaped magnetic strips 102.

To pull energy out of the system, the axle can be extended through the support frame whereby it can rotate gears driving an electrical generator, water pump, or the like. With manual hand-powered input working in conjunction with gravitational and magnetic forces, the motor can continue at a consistent pace. Without hand-powered input, the motor will eventually cease operation due to friction.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A motor device comprising:
a support frame adapted to support a plurality of magnetic strips;
a rotatable axle disposed in a horizontal orientation across the support frame above the magnetic strips; and
a plurality of levers having a linear bearing mounted to the axle and an arm slidably disposed inside the linear bearing;
wherein the arm has a pair of ends, each end attached to a magnet polarized to repel the magnetic strips forcing the arm to slide through the linear bearing, thereby shortening an end moving upward along the magnetic strips and elongating an end rotating downward opposing the magnetic strips causing the axle to rotate with the lever.

2) The motor device of claim 1, further comprising a hand crank connected to the axle whereby rotating the hand crank rotates the axle.

3) The motor device of claim 1, wherein the linear bearing is mounted to the axle in a perpendicular orientation.

4) The motor device of claim 1, wherein the plurality of levers are mounted to the axle at a 90 degree differential from each other.

5) The motor device of claim 1, wherein the magnet is a permanent magnet.

6) The motor device of claim 1, wherein the magnetic strips comprise a plurality of internal permanent magnets.

7) The motor device of claim 1, wherein the magnetic strips are aligned with the levers.

8) The motor device of claim 1, wherein the magnetic strips are L-shaped.

9) The motor device of claim 1, wherein the magnetic strips are equally spaced.

10) The motor device of claim 1, wherein the support frame is rectangular.

11) The motor device of claim 1, wherein the support frame comprises a plurality of legs.

12) The motor device of claim 1, wherein the support frame is composed of wood.

13) The motor device of claim 1, wherein the support frame is composed of plastic.

14) A motor device comprising:
a support frame adapted to support a plurality of magnetic strips;
a rotatable axle disposed in a horizontal orientation across the support frame above the magnetic strips;
a plurality of levers having a pair of linear bearings mounted to the axle and an arm slidably disposed inside each linear bearing;
wherein each arm has a free end attached to a magnet polarized to repel the magnetic strips forcing the arm to slide through the linear bearing, thereby shortening the arm moving upward along the magnetic strips and elongating the arm rotating downward opposing the magnetic strips causing the axle to rotate with the lever; and
a plurality of upper leading magnetic guides affixed to the support frame;
wherein the levers rotate between the upper leading magnetic guides.

15) The motor device of claim 14, further comprising a hand crank connected to the axle whereby rotating the hand crank rotates the axle.

16) The motor device of claim 14, wherein the plurality of levers are mounted to the axle at a 90 degree differential from each other.

17) The motor device of claim 14, wherein the linear bearings are affixed to the axle at a position parallel to each other.

18) The motor device of claim 14, wherein the magnetic strips are aligned with the levers.

19) The motor device of claim 14, wherein the magnetic strips comprise a plurality of internal permanent magnets.

20) The motor device of claim 14, wherein the upper leading magnetic guides are arcuate.
